(19) United States
(12) Patent Application Publication
(10) Pub. No.: US 2011/0198464 A1
(43) Pub. Date: Aug. 18, 2011

(54) FASTENING FITTING

(76) Inventor: Ralf Hoge, Radevormwald (DE)

(21) Appl. No.: 12/673,039

(22) PCT Filed: Aug. 14, 2008
(86) PCT No.: PCT/DE2008/001321

§ 371 Date: Feb. 11, 2010

(30) Foreign Application Priority Data
Aug. 14, 2007 (DE) 10 2007 038 712.3

(51) Int. Cl. F16M 13/02; F16B 2/02

(52) U.S. Cl. 248/223.41; 248/226.11

(57) ABSTRACT

The invention relates to a multi-part, separable fastening bracket, in particular for releasably attaching a seat or a seat bench to the floor of a motor vehicle. It is sought to refine said fastening bracket in such a way that it is of structurally simple design and requires little maintenance, and that both an insertion and also a removal and a longitudinal movement of a motor vehicle seat or of a seat bench of the first and second rows of seats can be carried out quickly and easily by a user. For this purpose, the fastening bracket is designed such that it has a number of elongate guide rails 1 and feet (2) assigned thereto in each case, which feet, are movably mounted in a position in the region of the upper side of the guide rails (1) in v-shaped guide portions, and wherein, for the purpose of arresting the feet in the position of engagement with the associated guide rail (1), clamping pieces are also provided which are clamped in the vertical direction against the underside of the guide rail profile by arresting means.

The present invention relates to a multi-part, separable fastening fitting for releasably attaching a structural unit, in particular a seat, a seat bench, a tool trolley or a wall element, to the floor of a motor vehicle.

Conventional motor vehicle seats are connected to the vehicle body in a longitudinally movable manner by means of two parallel-running seat rail pairs. The position of the seat can be arrested by locking means arranged in the region of the seat rail pairs, with it being possible for the arrested state to be eliminated by an occupant by means of an actuating lever, and for the seat to be moved along the rail which is fixed to the structure. One design variant of a seat rail pair is known from DE 100 39 511 A1. Here, sliding bodies in the form of balls are arranged in two guide tracks between the upper and the lower rail. Seat rail pairs of said type are complex to produce since precise manufacturing of the rail profiles is required. A removal of the seat is possible only with a considerable level of expenditure and a considerable spatial requirement.

Furthermore, EP 0 949 111 B1 discloses a modular fastening system having cam control for a movement of a vehicle seat in the longitudinal direction and for arresting the seat in the set position. A control cam which can be actuated by means of an actuating lever brings about a pivoting movement of locking means. In this way, it is possible for the seat structure elements to be arrested in the rails, the seat structure elements to be released for the purpose of longitudinally moving the motor vehicle seat, and to set the components of the fastening system into a position in which the motor vehicle seat can be removed. Said design is very complex on account of the multiplicity of components, and is associated with considerable production costs.

It is therefore an object of the present invention to refine a fastening bracket for releasably attaching a motor vehicle seat or the like in such a way that it is of structurally simple design and requires little maintenance, and that both an insertion and also a removal and a longitudinal movement of a motor vehicle seat, of a seat bench, of a tool trolley or of a wall element can be carried out quickly and easily by a user.

The present invention achieves said object by means of a fastening bracket having the features of claim 1.

By means of the design of the guide rails as an upwardly open, undercut rail profile which, for the purpose of guiding the feet, has v-shaped guide portions which run in the longitudinal direction and which are in contact with sliding surfaces, which run in a v-shape, of the feet, it is possible to realize a structurally simple guide mechanism. With a design of the guide portions with portions which are inclined obliquely inward in the direction of the central plane, said guide mechanism requires little maintenance since dirt cannot accumulate on the obliquely running guide portions.

Simple production is possible if the guide rails are formed as a sheet-metal profile, preferably as an aluminum profile.

It is also advantageous if the arresting means comprise a crank rod mechanism. In this way, it is possible to impart large clamping forces when the structural unit is clamped in the guide rails.

Yet further advantageous refinements of the present invention are specified in the subclaims.

The present invention is described below on the basis of exemplary embodiments, with reference being made to the appended drawings, in which:

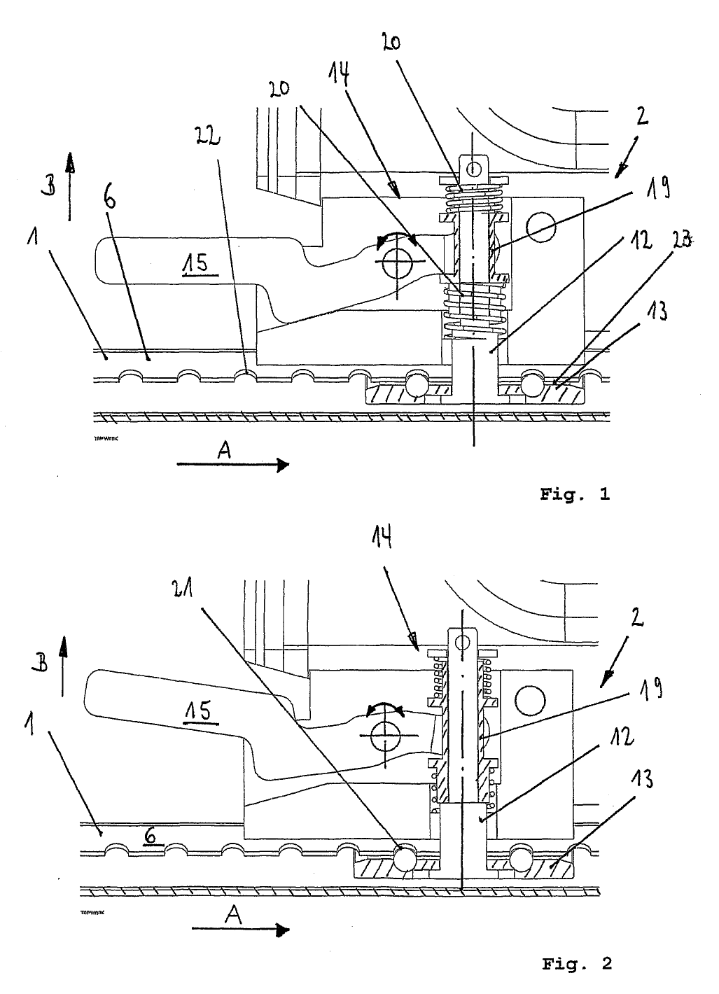

FIG. 1 shows a longitudinal section through a fastening bracket according to the present invention, in an arrested position;

FIG. 2 shows a longitudinal section through the fastening bracket according to FIG. 1, in an intermediate position;

FIG. 3 shows a longitudinal section through the fastening bracket according to FIG. 1, in a released position;

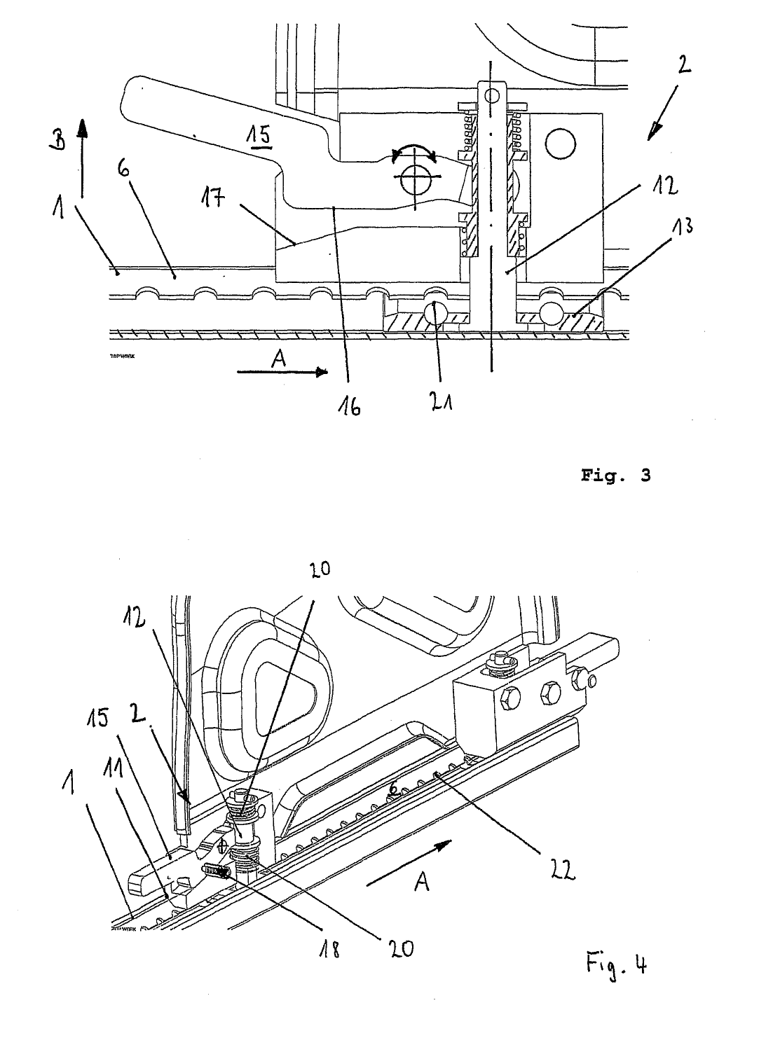

FIG. 4 shows a perspective view of a seat guiding part with fastening bracket and guide block;

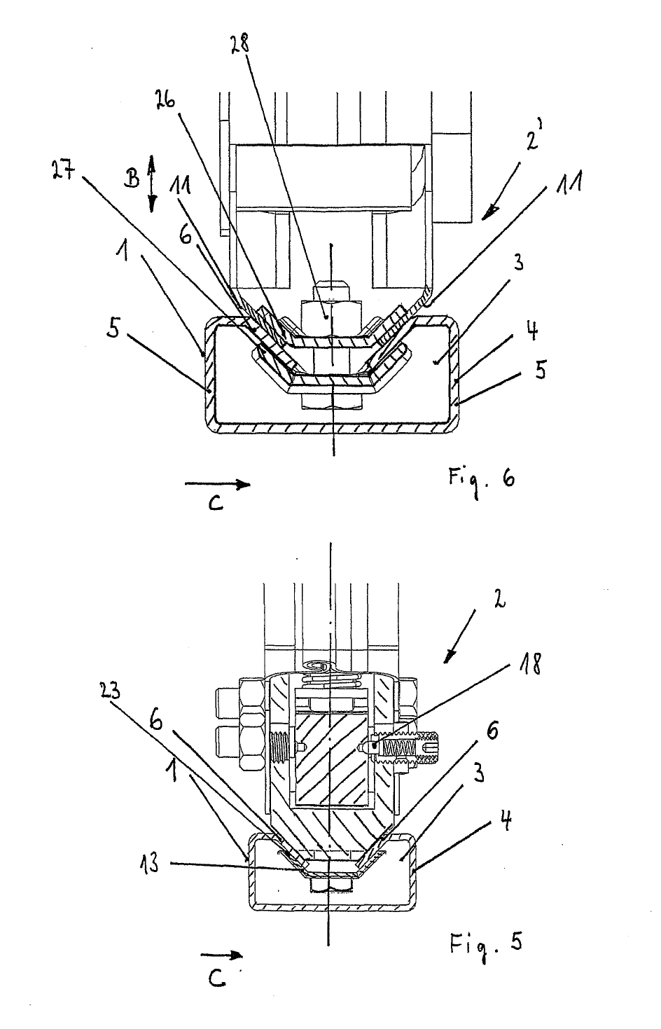

FIG. 5 shows a cross section through the fastening bracket;

FIG. 6 shows a cross section through a fastening bracket for mounting a seat or the like in a fixed position in the guide rail; and

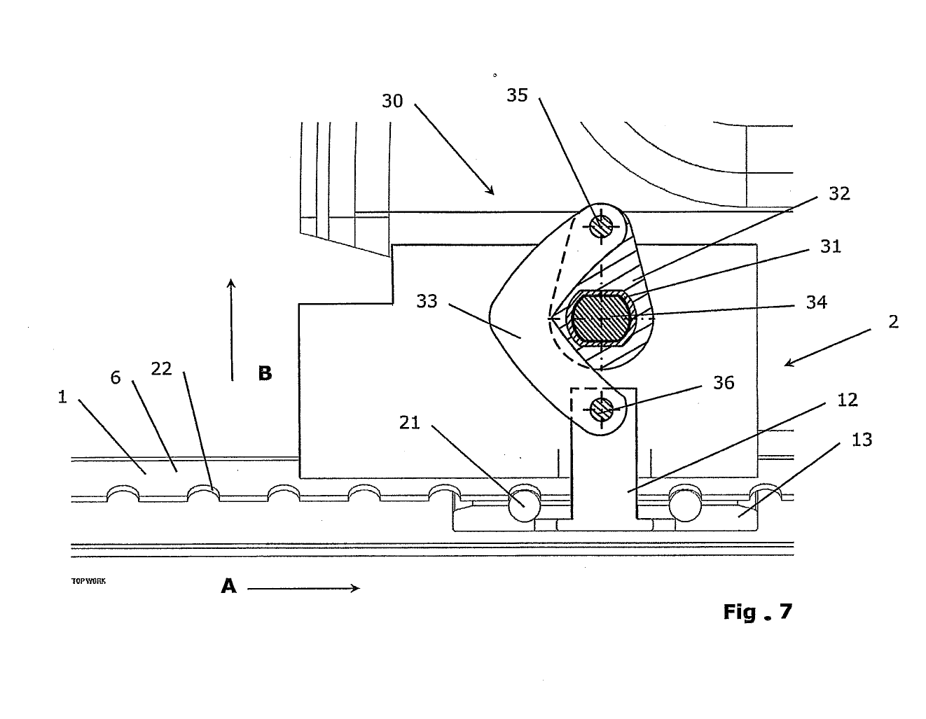

FIG. 7 shows a longitudinal section through the fastening bracket, with an alternative embodiment of an arresting means.

The present invention is described by way of example on the basis of an attachment of a seat in two guide rails which run parallel to one another in the longitudinal direction A and which are arranged on the vehicle floor. Instead of a vehicle seat, it would however also be possible for a partition wall to be held in a movable and arrestable manner in one or more guide rails. Further structural units held in a movable and arrestable manner by means of the fastening bracket according to the invention could be seat benches, tool trolleys, etc.

The fastening bracket, described below for attaching a seat in a motor vehicle, comprises two spaced-apart guide rails 1 which run parallel to one another in the longitudinal direction A and which are assigned in each case two feet 2 for attaching a front and a rear side region of the seat. FIGS. 1-3 illustrate only one foot 2 in a portion of a guide rail 1. The guide rails 1 are arranged so as to be fixed with respect to the vehicle structure or frame and are integrally formed for example as sheet-metal profiles, preferably as aluminum profiles or as rolled profiles. The guide rails 1 have, as can be seen in particular from the cross section in FIG. 6, channels 3 which run in the longitudinal direction and which are open to the upper side and are of undercut design. In this way, in the region of the channel 3, in each case one groove is formed which is delimited by a U-shaped profile 4. Those limbs 5 of the U-shaped profile 4 which point in the vertical direction B have horizontally inwardly running portions and adjoining obliquely inwardly aligned portions 6. The end regions of said portions 6 have a spacing to one another in the horizontal direction C. The portions 6 form a guiding/sliding surface for the feet 2 which are mounted so as to be movable along the guide rail 1. The guide portions 6 are preferably formed symmetrically with respect to the central plane M illustrated as a dash-dotted line in FIG. 5 and FIG. 6.

The feet 2 are connected to a structure which is assigned to a seat, a seat bench, a tool trolley or a wall element. As already explained above, the drawings of FIGS. 1-3 show only one foot on a portion of a guide rail. In the installed state, the feet 2 are mounted in a longitudinally movable manner on the guide rails 1. Furthermore, the feet have arresting means which make it possible to block and re-enable a longitudinal movement of the seat on the guide rails.

For the purpose of longitudinally moving the feet 2 on the obliquely running guide surfaces, the feet 2 have rest surfaces 11 assigned to the guiding/sliding surfaces 6. For easy adjustment of the seat in the guide rails 1, the corresponding guiding/sliding surfaces 6 and the rest surfaces 11 which are assigned thereto may be composed of a material with good sliding properties or provided with a coating. Here, the above-described guidance of the feet 2 on the guide rails 1 is unsusceptible to contamination and requires little maintenance. Dirt which accumulates in the channels 4 has no influence on the guiding/sliding surfaces 6/11 which are arranged so as to be completely covered, especially since said guiding/sliding surfaces are arranged horizontally spaced apart from the floor region of the motor vehicle interior space. The above-described prismatic guidance enables easy movement and precise alignment of the seat in the guide rails.

For easy movement of the seat in the guide rails, additional rollers may be arranged on the side region of the feet, which rollers roll on the horizontal portions of the guide rail profile during the longitudinal movement of the seat.

For the purpose of arresting the seat in the guide rails 1, the fastening bracket has tension rods 12 which, by means of clamping pieces 13 arranged on the end side, engage at both sides under the guide rail profile. The tension rods can be clamped upward in the vertical direction B against the underside of the guide surfaces 6 by way of arresting means 14 arranged in the foot 2.

As can be seen from FIGS. 1-3, the vertical movement of the tension rods 12, or of the clamping pieces 13 which are connected to the tension rods 12, is brought about by means of an actuating lever 15 which is rotatably mounted in the foot 2. The outwardly pointing first lever arm is provided, on its underside, with a contact portion 16 and, in the arrested position of the fastening bracket as shown in FIG. 1, lies on an obliquely running contact surface 17 of the foot 2. In said arrested position, the actuating lever 15 is locked by means of a horizontally running locking bolt 18. The locking bolt 18 is not shown in FIGS. 1-3. The second lever arm, which is opposite the first lever arm, is connected to the tension rod for the purpose of introducing a vertical movement. For this purpose, the lever arm, at its end region, engages around a guide sleeve 19 which is mounted on a bolt of the tension rod 12. The guide sleeve 19 is at both sides via pressure springs 20 on an upper and on a lower radially outwardly pointing annular web which is connected to the bolt. The bolt of the tension rod 12 is mounted in the foot 2 so as to be movable in the vertical direction and has the clamping piece 13 at its lower end region.

The clamping or arresting takes place by means of a downward pivoting of the first lever arm of the actuating lever 15 (see FIG. 1). The pivoting movement brings about a vertical upward movement of the tension rod 12 with clamping piece 13, such that the clamping surfaces 23 are pulled and clamped against the undersides of the guide surfaces 6 and said position is locked by means of the locking bolt. Additional arresting and blocking of the seat in the guide rails is obtained by means of arresting elements 21 arranged on the clamping pieces 13 of the tension rods. It can be seen from the figures that the arresting elements 21 are hemispherical beads which, upon arresting, engage into corresponding grooves 22 of the guide surfaces 6. From FIGS. 1-3 and the perspective view of FIGS. 4 and 5, it can be seen that, proceeding from the end regions, substantially semi-circular grooves 22 are formed into the portions 6. In this way, a toothed rack is formed along the guide rail 1. In one refinement of the concept of the invention, the grooves are formed only in partial regions of the guide rails 1.

When releasing the arrested state of the seat, the operator must firstly pull the locking bolt out of the locked position. The user can subsequently pivot the actuating lever 15 upward. The pivoting of the actuating lever upward brings about a downward vertical movement of the tension rod with clamping piece 13, as a result of which the arrested state is released. In said position which is shown in FIG. 3, the seat can be easily moved in the longitudinal direction. When the actuating lever is released from its upper position, the tension rod is pulled upward into an arrested position again by means of the spring preload. The actuating lever pivots downward and is locked by means of the locking bolt.

In a preferred refinement of the concept of the invention, additional stabilization elements are provided, spaced apart from one another in the longitudinal direction, on the obliquely running clamping surfaces 23 of the clamping pieces 13. Said stabilization elements, when the seat is arrested, engage into corresponding recesses formed in the guide surfaces 6 of the guide rails 1. The stabilization elements, which may be formed as rectangular teeth, and the corresponding rectangular grooves in the guide surfaces 6 are not illustrated in the figures. In said refinement, additional stabilization is obtained, such that in the event of a crash, the load-transmitting connection of clamping piece and guide rail is maintained.

In a further embodiment, only one actuating lever is provided for the purpose of releasing/arresting the seat. The pivoting movement of the actuating lever may then be transmitted to the other fastening brackets or the tension rods by means of an actuating linkage.

For the insertion of the seat into the guide rails 1, it is firstly possible in a first design variant for the tension rods 12 to be pushed, in a lowered position, into the rail profile in the longitudinal direction from the end of the guide rails 1. In a further refinement, some recesses could be formed into the guide rails 1 in the longitudinal direction in the region of the guide surfaces 6. The tension rods 12 can then be inserted into the guide rails 1 from above in the vertical direction in the region of the recesses. Here, there is no spatial requirement in the transverse direction C for the insertion of the seat. The seats both of the first and also of the second row can be easily and quickly removed and re-inserted and arrested.

In a further design variant (not illustrated), the locking state can be displayed to the user via visual means. The visual means may for example be mounted on the locking bolt. This increases safety, since the user can identify when the seat is not fully clamped and/or arrested in the guide rails 1.

FIG. 4 shows, in a perspective illustration, a side part of a seat having a front foot which is held in a guide rail and having a rear foot. The front foot corresponds to the refinement described with regard to FIGS. 1-3, with a tension rod, clamping piece, arresting means and actuating lever. The rear foot is formed merely as a sliding/gliding block and cannot be clamped to the guide rail by arresting means.

FIG. 5 shows, in cross section, a fastening bracket in the arrested position. Said illustration shows the locking bolt 18, which is preloaded by means of a pressure spring 25. In the illustrated arrested position, the locking bolt 18, which is mounted so as to be movable in the horizontal direction, engages into a recess formed into a side region of the actuating lever 15. In this way, the actuating lever 15 is locked in said position by the locking bolt 18. Said locked state can be released by means of a knob arranged on the end of the locking bolt 18. To release the arrested state and to longitudinally adjust the seat, a user can pull the knob outward in the horizontal direction, thereby releasing the locking of the actuating lever 15.

FIG. 6 shows, in cross section, a foot 2′ which is fixedly clamped to the guide rail 1. Here, the foot bears with its obliquely running corresponding clamping surfaces, which face toward the guide surfaces 6, against the guide surfaces 6. Clamping pieces 26, 27 bear against the underside of the guide surfaces 6 and against the surfaces situated opposite the contact surfaces, which clamping pieces 26, 27 can be clamped against one another by means of screw connections 28 and thereby arrest the feet 2 in the guide rails 1. To change the position of the seat or to remove the seat from the guide rails 1, the screw connections 28 must be released.

The invention has been described by way of example on the basis of FIGS. 1-4, but is not restricted to said embodiment. Instead of the actuating lever with lever mechanism described above, by means of which a vertical movement and arresting of the feet can be achieved by pivoting the actuating lever, it is also possible to provide other known clamping means and mechanisms which bring about a vertical movement. It is for example possible to provide knee lever arrangements or elements with wedge surfaces or eccentric arrangements which are movable relative to one another.

FIG. 7 shows a further embodiment of the arresting means 30. For the purpose of arresting the seat in the guide rails 1, the fastening bracket in said alternative design variant also has tension rods 12 which engage under the guide rail profile at both sides by means of clamping pieces 13 arranged on the end side. By way of arresting means 30, which are arranged in the foot 2 and which comprise a crank rod mechanism, the tension rods 12 can be clamped upward in the vertical direction B against the underside of the guide surfaces 6.

The crank rod mechanism is composed substantially of a sleeve 31, an intermediate lever 32 and two knee levers 33. The sleeve 31 is formed as a hollow cylindrical sleeve and has opposite flattened regions. The intermediate lever 32 has a corresponding first bore, which is matched to the outer contour of the sleeve 31, and is pushed centrally onto the sleeve 31. On account of the above-described outer contour of the sleeve 31, the intermediate lever 32 is fixed in a rotationally secured manner to the sleeve 31. The intermediate lever 32 has a second bore at its end region opposite the first bore. The intermediate lever 32 is coupled, by means of a pin 35 guided through the second bore, to a knee lever pair arranged laterally on the intermediate lever 32. For this purpose, the two knee levers 33 have, in the upper end region, a holding bore for the pin 35. The lower end region of the knee lever 33 likewise has a bore, by means of which coupling to the tension rod 12 is obtained by way of a further pin 36.

The vertical movement of the tension rods 12 and of the clamping pieces 13 which are connected to the tension rods 12 is brought about by means of an actuating lever which is rotatably mounted in the foot 2. Here, the actuating lever is rotationally fixedly mounted on an axle 34. Said axle 34 is guided through the bore of the sleeve 31 of the crank rod mechanism, is connected in a positively locking manner to the sleeve 31 and is rotatably mounted at the end slide in the housing of the foot 2.

Here, the rotary movement of the axle 34 is converted, via the sleeve 31, the intermediate lever 32 and subsequently the knee lever 33, into a translatory movement of the tension rod 12 such that the feet 2 can be clamped and released.

1. A multi-part, separable fastening bracket, in particular for releasably attaching a structural unit to the floor of a motor vehicle, with the structural unit having a number of feet (2) which are held in a movable and arrestable manner in a number of guide rails (1) which are connected, so as to be fixed with respect to the frame, to the vehicle floor, with the guide rails (1) having an upwardly open, undercut rail profile and, for the purpose of guiding the feet (2), having v-shaped guide portions (6) which run in the longitudinal direction and which are in contact with sliding surfaces (11), which run in a v-shape, of the feet (2), and with it being possible, for arresting at least one foot (2) in the position of engagement with the associated guide rail (1), for a tension rod (12) to be clamped upward in the vertical direction against the underside of the rail profile in a positively locking and non-positively locking fashion by arresting means (14;30).

2. (canceled)

3. The multi-part, separable fastening bracket according to claim 1, with those guide portions (6) which are situated oppositely with respect to a central plane (M) being of equal width and having the same inclination.

4. The multi-part, separable fastening bracket according to claim 3, with the guide portions (6) being formed symmetrically with respect to the central plane (M).

5. The multi-part, separable fastening bracket according to claim 4, with the guide portions (6), which run in a v-shape, being obliquely inwardly inclined portions.

6. The multi-part, separable fastening bracket according to claim 5, with the tension rod (12) having, at the end side, a clamping piece (13) with clamping surfaces (23) which run in a v-shape and which, when the foot (2) is arrested in the guide rail (1), can be clamped against the underside of the guide portion (6).

7. The multi-part, separable fastening bracket according to claim 6, with grooves (22) which are arranged spaced apart in the longitudinal direction being formed into the guide portions (6), into which grooves (22) arresting elements (21) which are arranged on the clamping surfaces (23) of the clamping pieces engage upon arresting.

8. The multi-part, separable fastening bracket according to claim 7, with the grooves (22) being formed as semi-circular grooves (22) formed into the guide portions and with the arresting elements (21) being formed as hemispherical beads.

9. The multi-part, separable fastening bracket according to claim 8, wherein, for the purpose of removing the structural units from the guide rails (1), the guide portions (6) are provided with recesses for vertically leading out the tension rods (12) with clamping pieces (13).

10. The multi-part, separable fastening bracket according to claim 9, with additional stabilization elements being provided, spaced apart from one another in the longitudinal direction, on the obliquely running clamping surfaces (23), which stabilization elements, when the seat is arrested, engage into corresponding recesses formed in the guide surfaces (6) of the guide rails (1).

11-16. (canceled)

17. The multi-part, separable fastening bracket according to claim 10, wherein, for the purpose of additional guidance during the movement of the feet (2) along the guide rails (1), rollers are arranged laterally on the feet (2), which rollers roll on horizontally running guide surfaces of the guide rails (1) during the movement.

18. The multi-part, separable fastening bracket according to claim 17, with the structural unit being a seat, a seat bench, a tool trolley or a wall element.

19. A multi-part, separable fastening bracket, in particular for releasably attaching a structural unit to the floor of a motor vehicle, with the structural unit having a number of feet (2) which are held in a movable and arrestable manner in a number of guide rails (1) which are connected, so as to be fixed with respect to the frame, to the vehicle floor, with the guide rails (1) having an upwardly open, undercut rail profile and, for the purpose of guiding the feet (2), having v-shaped guide portions (6) which run in the longitudinal direction and which are in contact with sliding surfaces (11), which run in a v-shape, of the feet (2), and with it being possible, for arresting at least one foot (2) in the position of engagement with the associated guide rail (1), for a tension rod (12) to be clamped upward in the vertical direction against the underside of the rail profile in a positively locking and non-positively locking fashion by arresting means (14;30), and whereas the arresting means comprising an actuating lever (15) which is pivotably mounted in the foot (2) and the pivoting movement of which brings about a vertical movement of the tension rod (12).

20. The multi-part, separable fastening bracket according to claim 19, with it being possible for the actuating lever (15) to be locked in the downwardly pivoted position by means of a locking bolt (18).

21. The multi-part, separable fastening bracket according to claim 20, with the actuating lever (15) engaging with a lever arm around a guide sleeve (19) which is mounted on a bolt of the tension rod (12), and with it being possible by means of the pivoting movement of the actuating lever (15) to bring about a movement of the guide sleeve.

22. The multi-part, separable fastening bracket according to claim 21, with the actuating lever (15) being held in a spring-preloaded fashion at both sides in the vertical direction.

23. The multi-part, separable fastening bracket according to claim 22, with the spring preload being provided by means of pressure springs (20) which are supported in the vertical direction at both sides between the guide sleeve and the bolt.

24. The multi-part, separable fastening bracket according to claim 19, with the guide portions (6), which run in a v-shape, being obliquely inwardly inclined portions.

25. The multi-part, separable fastening bracket according to claim 24, with the tension rod (12) having, at the end side, a clamping piece (13) with clamping surfaces (23) which run in a v-shape and which, when the foot (2) is arrested in the guide rail (1), can be clamped against the underside of the guide portion (6).

26. The multi-part, separable fastening bracket according to claim 25, with grooves (22) which are arranged spaced apart in the longitudinal direction being formed into the guide portions (6), into which grooves (22) arresting elements (21) which are arranged on the clamping surfaces (23) of the clamping pieces engage upon arresting.

27. A multi-part, separable fastening bracket, in particular for releasably attaching a structural unit to the floor of a motor vehicle, with the structural unit having a number of feet (2) which are held in a movable and arrestable manner in a number of guide rails (1) which are connected, so as to be fixed with respect to the frame, to the vehicle floor, with the guide rails (1) having an upwardly open, undercut rail profile and, for the purpose of guiding the feet (2), having v-shaped guide portions (6) which run in the longitudinal direction and which are in contact with sliding surfaces (11), which run in a v-shape, of the feet (2), and with it being possible, for arresting at least one foot (2) in the position of engagement with the associated guide rail (1), for a tension rod (12) to be clamped upward in the vertical direction against the underside of the rail profile in a positively locking and non-positively locking fashion by arresting means (14;30), and whereas the arresting means (30) comprising a crank rod mechanism (31, 32, 33, 34, 35, 36).

28. The multi-part, separable fastening bracket according to claim 27, with the guide portions (6), which run in a v-shape, being obliquely inwardly inclined portions.

29. The multi-part, separable fastening bracket according to claim 28, with the tension rod (12) having, at the end side, a clamping piece (13) with clamping surfaces (23) which run in a v-shape and which, when the foot (2) is arrested in the guide rail (1), can be clamped against the underside of the guide portion (6).

30. The multi-part, separable fastening bracket according to claim 29, with grooves (22) which are arranged spaced apart in the longitudinal direction being formed into the guide portions (6), into which grooves (22) arresting elements (21) which are arranged on the clamping surfaces (23) of the clamping pieces engage upon arresting.

31. The multi-part, separable fastening bracket according to claim 27, wherein, for the purpose of additional guidance during the movement of the feet (2) along the guide rails (1), rollers are arranged laterally on the feet (2), which rollers roll on horizontally running guide surfaces of the guide rails (1) during the movement.

32. The multi-part, separable fastening bracket according to claim 27, with the structural unit being a seat, a seat bench, a tool trolley or a wall element.
